(19) United States
(12) Patent Application Publication
(10) Pub. No.: US 2021/0302173 A1
(43) Pub. Date: Sep. 30, 2021

(54) SYSTEM AND METHOD OF ESTIMATING NAVIGATION TIME OF A VEHICLE

(71) Applicant: Wipro Limited, Bangalore (IN)

(72) Inventors: Gourab MITRA, Kolkata (IN); Sayanshree GHOSH, Kolkata (IN); Arnik SARKAR, Murshidabad (IN)

(21) Appl. No.: 16/933,201

(22) Filed: Jul. 20, 2020

(30) Foreign Application Priority Data
Mar. 31, 2020 (IN) 202041014487

(51) Int. Cl. G01C 21/34; G06N 20/00

(52) U.S. Cl. CPC G01C 21/3415; G06N 20/00; G01C 21/3446; G01C 21/3492

(57) ABSTRACT

The present invention relates to a method of estimating a navigation time of a vehicle. The method comprises obtaining at least one navigation route from a source location to a destination location from a user via a user device. Further, receiving in real-time at least one of a traffic information, information related to one or more events in a geographical area, a weather information and information related to a roadblock denoted as one or more factors. Finally, computing an estimated time for navigating from the source location to the destination location via the at least one navigation route based on identified one or more geographical locations, and one or more factors causing delay and a type of the vehicle, where the estimated time for the at least one navigation route is provided to the user for navigating the vehicle.

### TECHNICAL FIELD

The present disclosure relates to the field of Global Positioning System (GPS) based navigation of a vehicle. Particularly, but not exclusively, the present disclosure relates to a method of estimating a navigation time of a vehicle.

### BACKGROUND

Generally, navigation devices are widely known and used in vehicles and hand-held devices to indicate a location of a user and for determining a navigation route. Further, the navigation devices provide an estimated time for the determined navigation route. The existing techniques estimate the time based on a distance of the navigation route and an average speed of the vehicle along the navigation route. Further, the estimated time is dynamically modified during the navigation of the vehicle in the navigation route. Also, the estimated time is updated only upon the vehicle arriving at a geographical location with increased traffic. Therefore, the existing techniques lack the ability to predict an accurate navigation time before the start of a journey via the navigation route.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Other embodiments and aspects of the disclosure are described in detail herein and are considered a part of the claimed disclosure.

Disclosed herein is a method of estimating navigation time of a vehicle. The method comprises obtaining at least one navigation route from a source location to a destination location from a user via a user device. Further, the method comprises receiving in real-time at least one of a traffic information, information related to one or more events in a geographical area, a weather information and information related to a roadblock. Finally, the method comprises computing an estimated time for navigating from the source location to the destination location via the at least one navigation route based on identified one or more geographical locations, and one or more factors comprising the traffic information, information related to the one or more events in the geographical area, the weather information and information related to the roadblock causing delay, and a type of the vehicle, where the estimated time for the at least one navigation route is provided to the user for navigating the vehicle.

Embodiments of the present disclosure discloses a computing system for estimating a navigation time of a vehicle. The computing system comprises a processor and a memory communicatively coupled to the processor, wherein the memory stores the processor instructions, which, on execution, causes the processor to obtain at least one navigation route from a source location to a destination location from a user via a user device. Further, the instructions cause the processor to receive in real-time at least one of a traffic information, information related to one or more events in a geographical area, a weather information and information related to a roadblock. Finally, the instructions cause the processor to compute an estimated time for navigating from the source location to the destination location via the at least one navigation route based on identified one or more geographical locations, and one or more factors comprising the traffic information, information related to the one or more events in the geographical area, the weather information and information related to the roadblock causing delay and a type of the vehicle, wherein the estimated time for the at least one navigation route is provided to the user for navigating the vehicle.

Embodiments of the present disclosure discloses a non-transitory computer readable medium including instructions stored thereon that when processed by at least one processor cause a device to perform operations comprising obtaining at least one navigation route from a source location to a destination location from a user via a user device. Further, receiving in real-time at least one of a traffic information, information related to one or more events in a geographical area, a weather information and information related to a roadblock. Finally, computing an estimated time for navigating from the source location to the destination location via the at least one navigation route based on identified one or more geographical locations, and one or more factors comprising the traffic information, information related to the one or more events in the geographical area, the weather information and information related to the roadblock causing a delay, and a type of the vehicle, wherein the estimated time for the at least one navigation route is provided to the user for navigating the vehicle.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary environment for estimating a navigation time of a vehicle, in accordance with some embodiments of the present disclosure;

FIG. 2 shows a detailed block diagram of a computing system, in accordance with some embodiments of the present disclosure;

FIG. 3 shows a flowchart illustrating method steps for estimating a navigation time of a vehicle, in accordance with some embodiment of the present disclosure;

FIG. 4A shows an exemplary at least one navigation route selected by a user, in accordance with some embodiments of the present disclosure;

FIG. 4B shows an exemplary identification of one or more geographical locations causing a delay in the navigation route, in accordance with some embodiments of the present disclosure;

FIG. 4C shows an exemplary estimated time computed before the starting navigation based on one or more geographical locations and one or more factors causing the delay, in accordance with some embodiments of the present disclosure;

FIG. 5 shows an exemplary computer system for estimating a navigation time of a vehicle, in accordance with some embodiments of the present disclosure;

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

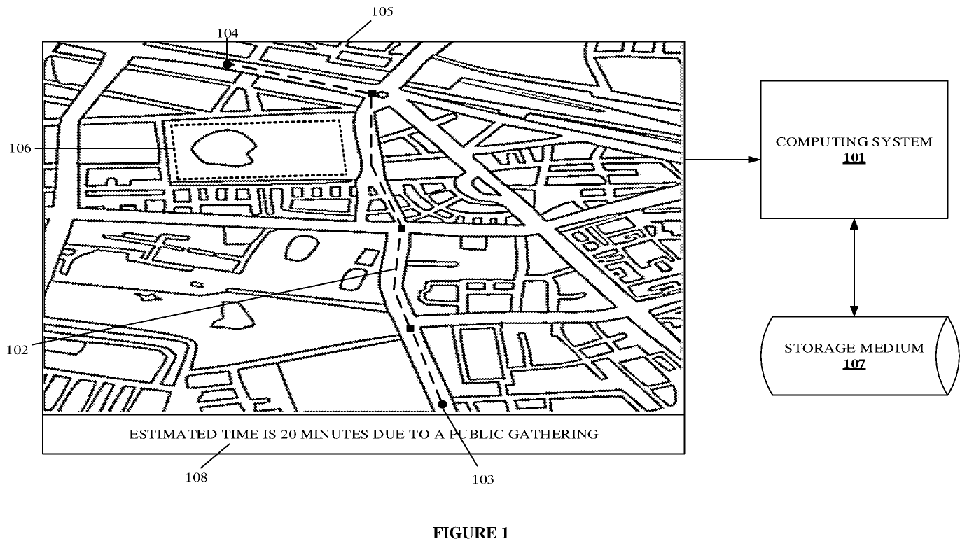

FIG. 1 shows an exemplary environment for estimating a time for navigating a vehicle, in accordance with some embodiments of the present disclosure.

In an embodiment, a user (not shown in Figure) navigating via a vehicle (not shown in Figure) may use the computing system (101) for estimating a time required to travel from a source location (103) to a destination location (104) using at least one navigation route (102). The vehicle may include, for example, a motorbike, scooter, a bus, a car, a truck and the like. The computing system (101) may obtain the at least one navigation route (102) from the user via a user device (105). For example, the user device (105) may be an in-vehicle navigation unit, a smartphone with Global Positioning System (GPS), a standalone GPS based navigation unit and the like. Further, the computing system (101) may be implemented in at least one of the user device (105), the vehicle and the like.

In an embodiment, the computing system (101) may obtain or receive at least one navigation route (102) from the source location (103) to the destination location (104) from the user via the user device (105). The user device (105) may include a user interface for interacting with the user. The user device (105) may receive the source location (103) and the destination location (104) from the user via the user interface. In one embodiment, the user device (105) may determine the source location (103) using the GPS associated with the user device (105). Further, the user device (105) may determine at least one navigation route (102) from the source location (103) to the destination location (104) based on one or more user preferences using a geographical map, and a traffic information stored in the storage medium (107). The one or more user preferences may include at least one of a shortest navigation time, navigation route without toll fees, navigation route without ferries and the like. The navigation route includes at least one of a current location of the vehicle, current vehicle speed, distance to the destination location (104), subsequent turns to be taken by the vehicle along the navigation route, an average vehicle speed along the navigation route, estimated arrival time to the destination location (104). The estimated arrival time is computed based on the distance to the destination location (104), traffic information, the average speed of other vehicles navigating along the navigation route.

In an embodiment, the computing system (101) may receive in real-time at least one of a traffic information, information related to one or more events in a geographical area, a weather information, and information related to a roadblock. In a first example, the traffic information may include traffic alerts, traffic announcements, and the like. In a second example, information related to the one or more events in the geographical area may include political rallies, sports tournaments, entertainment shows, protests, funfairs, and the like. In a third example, the weather information may include current weather reports across one or more geographical areas, weather forecasts across the one or more geographical areas and the like. In a fourth example, the information related to the roadblock may include a conversion of a road having a two-way navigation into a single way navigation, roadblock due to waterlogging, tree fall, snow, accident, a diversion, increased number of people/vehicles on the road due to offices and educational institutions, and the like. The traffic information, information related to the one or more events, the weather information, the information related to the roadblock may be received from one or more sources and stored in the storage medium (107). For example, the one or more sources may include a television broadcast, a radio broadcast, one or more servers providing news updates, a vehicular networks, a wireless sensor network, a satellite network and the like.

In an embodiment, the computing system (101) may compute an estimated time (108) for navigating from the source location (103) to the destination location (104) via the at least one navigation route (102) based on identified one or more geographical locations (106), and one or more factors comprising the traffic information, information related to the one or more events in the geographical area, the weather information and information related to the roadblock causing a delay, and a type of the vehicle. The estimated time (108) for the at least one navigation route (102) is provided to the user for navigating the vehicle. The phrase “one or more factors” is used interchangeably in the present disclosure to denote at least one of the traffic information, information related to the one or more events in the geographical area, the weather information, and information related to the roadblock. The computing system (101) may identify the one or more geographical locations (106) causing the delay using the geographical map associated with the navigation route. The one or more geographical locations (106) are indicative of a public gathering present in the vicinity of the at least one navigation route (102) causing the delay to navigate the vehicle. For example, the one or more geographical locations (106) may be a sports stadium, a movie theater, a shopping mall, a convention hall, a park and the like. In another example, the computing system (101) may identify the one or more geographical locations (106) as a stadium present along the navigation route as shown in FIG. 1. The computing system (101) may identify the one or more factors causing the delay by filtering at least one of one or more factors based on the one or more geographical locations (106) causing the delay, the type of the vehicle, type of a path and timestamp of a journey from the source location (103) to the destination location (104). For example, a political meeting in the one or more geographical locations (106) at a faraway distance from the at least one navigation route (102) may not cause the delay along the navigation route and hence may be filtered by discarding an information about the political meeting from the one or more factors. In another example, the sports tournament ongoing in the stadium may be filtered as a relevant information from the one or more factors because the stadium is identified as the one or more geographical locations (106) causing the delay in the vicinity of the at least one navigation route (102) as shown in FIG. 1.

The computing system (101) may compute the estimated time (108) for the at least one navigation route (102) based on a supervised learning technique using the one or more factors, the one or more geographical locations (106), causing the delay and the type of the vehicle. In an embodiment, the computing system (101) may split the at least one navigation route (102) into a plurality of nodes (denoted by square boxes) and a plurality of links (denoted by dotted lines) with one or more geographical locations (106) denoted by one or more polygons as shown in FIG. 1. The nodes may indicate an intersection of roads and the links may indicate a route from one node to a subsequent node. The computing system (101) determines a plurality of estimated time (108) for navigating each link among the plurality of links and computes the estimated time (108) for the navigation route by adding the plurality of estimated time (108).

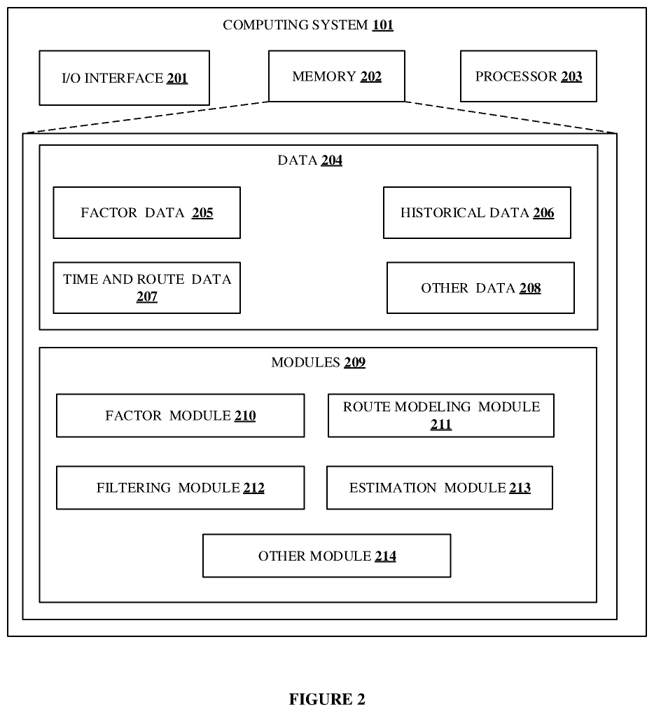

FIG. 2 shows a detailed block diagram of the computing system (101), in accordance with some embodiments of the present disclosure.

The computing system (101) may include a Central Processing Unit (“CPU” or “processor”) (203) and a memory (202) storing instructions executable by the processor (203). The processor (203) may include at least one data processor for executing program components for executing user or system-generated requests. The memory (202) may be communicatively coupled to the processor (203). The computing system (101) further includes an Input/Output (I/O) interface (201). The I/O interface (201) may be coupled with the processor (203) through which an input signal or/and an output signal may be communicated. In one embodiment, the source location (103) and the destination location (104) may be received through the I/O interface (201).

In some implementations, the computing system (101) may include data (204) and modules (209). As an example, the data (204) and modules (209) may be stored in the memory (202) configured in the computing system (101). In one embodiment, the data (204) may include, for example, a factor data (205), a historical data (206), a time and route data (207), and other data (208). In the illustrated FIG. 2, data (204) are described herein in detail. In an embodiment, the storage medium (107) may be implemented in the computing system (101). In another embodiment, the storage medium (107) may be external to the computing system (101). The data (204) and the storage medium (107) may be used interchangeably in the disclosure herein.

In an embodiment, the factor data (205) may include information related to the one or more factors. The one or more factors include the traffic information, information related to the one or more events in the geographical area, the weather information and information related to the roadblock. In a first example, the traffic information may include traffic alerts, traffic announcements, and the like. In a second example, information related to the one or more events in the geographical area may include political rallies, sports tournaments, entertainment shows, protests, funfairs, and the like. In a third example, the weather information may include current weather reports across one or more geographical areas, weather forecasts across the one or more geographical areas and the like. In a fourth example, the information related to the roadblock may include a conversion of a road having a two-way navigation into a single way navigation, roadblock due to waterlogging, tree fall, snow, accident, a diversion, increased number of people/vehicles on the road due to offices and educational institutions, and the like.

In an embodiment, the historical data (206) includes a unique value associated with each of the at least one navigation route (102) previously navigated by the vehicle, timestamp including the date of the navigation along the at least one navigation route (102), the type of the vehicle (for example, the motorbike, the scooter, the car, the truck and the like), the estimated time (108) for the at least one navigation route (102) previously navigated by the vehicle, an actual time taken by the vehicle to navigate the at least one navigation route (102), the one or more factors causing the delay for the at least one navigation route (102) previously navigated by the vehicle, weights associated with the one or more factors. The weights are indicative of an amount the delay caused by the one or more factors. If a value associated with the weights are high, then the possibility of causing delay is higher. Alternatively, if the value associated with the weights are low, then the possibility of causing delay is lower. For example, if a new movie released in the movie theater may cause a roadblock and the weights associated with the new movie release may be 6. In another example, every day at 3:00 PM a number of vehicles may cause a traffic congestion due to the educational institution and the weights associated with the educational institution may be 2.4.

In an embodiment, the time and route data (207) may include estimated time (108) for the at least one navigation route (102), a model of the at least one navigation route (102) using the plurality of nodes, the plurality of links and the one or more polygons. Further, the time and route data (207) may include a map associated with the one or more geographical areas, the type of the vehicle, the source location (103), the destination location (104), and the one or more user preferences.

In an embodiment, the other data (208) may include at least one of parameters associated with a supervised learning technique for computing the estimated time (108) and the like.

In some embodiments, the data (204) may be stored in the memory (202) in the form of various data structures. Additionally, the data (204) may be organized using data models, such as relational or hierarchical data models. The other data (208) may store data, including temporary data and temporary files, generated by the modules (209) for performing the various functions of the computing system (101).

In some embodiments, the data (204) stored in the memory (202) may be processed by the modules (209) communicatively coupled to the processor (203) of the computing system (101). The modules (209) may be stored within the memory (202) as shown in FIG. 2. In one embodiment, the modules (209) may be present outside the memory (202) and implemented as hardware. As used herein, the term modules (209) may refer to an Application Specific Integrated Circuit (ASIC), an FPGA (Field Programmable Gate Array), an electronic circuit, a processor (shared, dedicated, or group) that execute one or more software or firmware programs, a combinational logic circuit, and/or other suitable components that provide the described functionality.

In one implementation, the modules (209) may include, for example, a factor module (210), a route modeling module (211), a filtering module (212), an estimation module (213) and other module (214). It may be appreciated that such aforementioned modules (209) may be represented as a single module or a combination of different modules.

In an embodiment, the factor module (210) may be used to receive in real-time at least one of the traffic information, information related to the one or more events in the geographical area, the weather information and information related to the roadblock. The traffic information, information related to the one or more events, the weather information, the information related to the roadblock may be received from one or more sources. For example, the one or more sources may include the television broadcast, the radio broadcast, the one or more servers providing news updates, the vehicular networks, the wireless sensor network, the satellite network and the like.

In an embodiment, the route modeling module (211) may be used to model the at least one navigation route (102) using the plurality of nodes, the plurality of links and the one or more polygons. The plurality of nodes indicates the intersection of roads, the plurality of links indicates a road or the route along the at least one navigation route (102), and the one or more polygons indicates the one or more geographical locations (106) causing a delay along the navigation route. The person skilled in the art appreciates the use of one or more graph theory techniques to model the at least one navigation route (102). Further, the route modeling module (211) may be used to determine the weights associated with the one or more factors. The weights are determined based on the amount of delay caused in navigating the vehicle along the navigation route. Furthermore, the route modeling module (211) may be used to modify the weights associated with at least one of the one or more factors based on a deviation in a historical estimated time (108) and the actual time for navigating the vehicle from the source location (103) to the destination location (104) along the at least one navigation route (102).

In an embodiment, the filtering module (212) may be used to identify the one or more geographical locations (106) causing the delay based on at least one of a distance between the one or more geographical locations (106) and the at least one navigation route (102) and a time taken to navigate from the one or more geographical locations (106) to a link among the plurality of links in the at least one navigation route (102). For example, the one or more geographical locations (106) such as a sports stadium at the distance of 100 meters from the at least one navigation route (102) may cause the delay and the one or more geographical locations (106) such as the movie theater at the distance of 500 meters from the at least one navigation route (102) may not cause the delay.

In an embodiment, the estimation module (213) may be used to determine the estimated time (108) for navigating the vehicle from the source location (103) to the destination location (104) for the at least one navigation route (102) based on the supervised learning technique using weights, the one or more geographical locations (106) causing the delay and the type of the vehicle. For example, the supervised learning technique may be a regression based model. The person skilled in the art appreciates the use of one or more supervised learning techniques for determining the estimated time (108).

In an embodiment, the other module (214) may be used to receive the at least one navigation route (102) selected by the user among one or more routes from the user device (105).

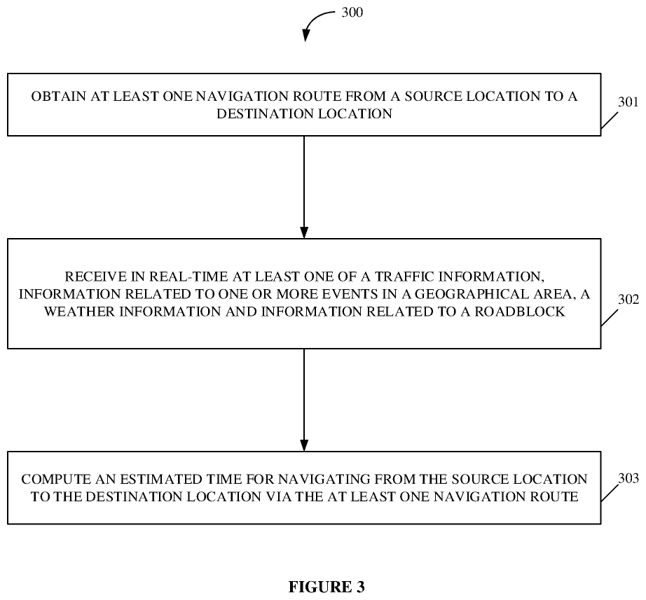

FIG. 3 shows a flowchart illustrating method steps for estimating the navigation time of the vehicle, in accordance with some embodiment of the present disclosure.

The order in which the method 300 may be described is not intended to be construed as a limitation, and any number of the described method blocks may be combined in any order to implement the method. Additionally, individual blocks may be deleted from the methods without departing from the scope of the subject matter described herein. Furthermore, the method may be implemented in any suitable hardware, software, firmware, or combination thereof.

At the step 301, the computing system (101) may obtain the at least one navigation route (102) from the source location (103) to the destination location (104) from the user via the user device (105).

In an embodiment, the computing system (101) may obtain the at least one navigation route (102) by receiving the at least one navigation route (102) selected by the user among one or more routes from the source location (103) to the destination location (104) using the user device (105). The user device (105) may receive the source location (103) and the destination location (104) from the user via the user interface. In one embodiment, the user device (105) may determine the source location (103) using the GPS associated with the user device (105). Further, the user device (105) may determine at least one navigation route (102) from the source location (103) to the destination location (104) based on one or more user preferences using a geographical map, and a traffic information stored in the storage medium (107). The one or more user preferences may include at least one of shortest navigation time, navigation route without toll fees, navigation route without ferries and the like. The navigation route includes at least one of a current location of the vehicle, current vehicle speed, distance to the destination location (104), subsequent turns to be taken by the vehicle along the navigation route, an average vehicle speed along the navigation route, estimated arrival time to the destination location (104). The estimated arrival time is computed based on the distance to the destination location (104), traffic information, the average speed of other vehicles navigating along the navigation route.

At the step 302, the computing system (101) may receive in real-time at least one of the traffic information, information related to the one or more events in the geographical area, the weather information and information related to the roadblock.

In an embodiment, the computing system (101) may receive the one or more factors including at least one of the traffic information, information related to the one or more events in the geographical area, the weather information and information related to the roadblock. In a first example, the traffic information may include traffic alerts, traffic announcements, a traffic congestion and the like. In a second example, information related to the one or more events in the geographical area may include political rallies, sports tournaments, entertainment shows, protests, funfairs, and the like. In a third example, the weather information may include current weather reports across one or more geographical areas, weather forecasts across the one or more geographical areas and the like. In a fourth example, the information related to the roadblock may include a conversion of a road having a two-way navigation into a single way navigation, roadblock due to waterlogging, tree fall, snow, accident, the diversion, increased number of people/vehicles on the road due to offices and educational institutions, and the like.

In an embodiment, the one or more factors may be received from the one or more sources and stored in the storage medium (107). For example, the one or more sources may include a television broadcast, a radio broadcast, one or more servers providing news updates, a vehicular networks, a wireless sensor network, a satellite network and the like.

At the step 303, the computing system (101) may compute the estimated time (108) for navigating from the source location (103) to the destination location (104) via the at least one navigation route (102) based on the identified one or more geographical locations (106), and the one or more factors comprising the traffic information, information related to the one or more events in the geographical area, the weather information and information related to the roadblock causing the delay, and the type of the vehicle. The estimated time (108) for the at least one navigation route (102) is provided to the user for navigating the vehicle.

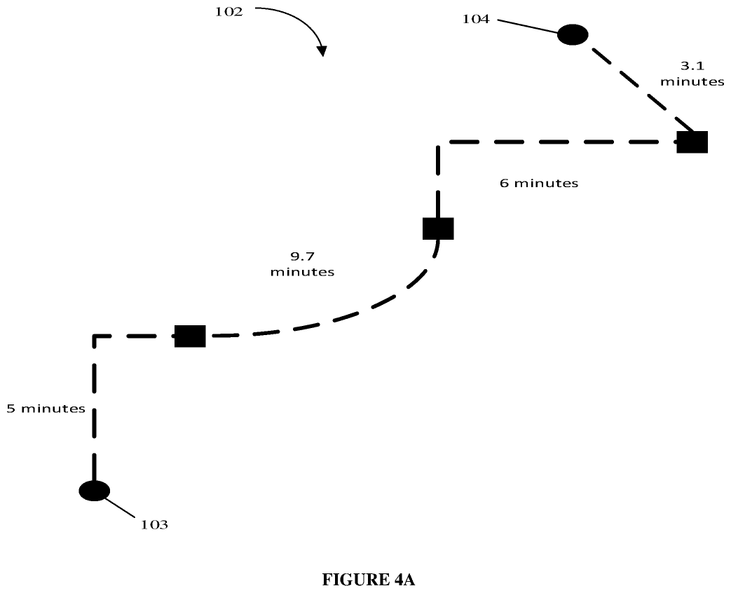

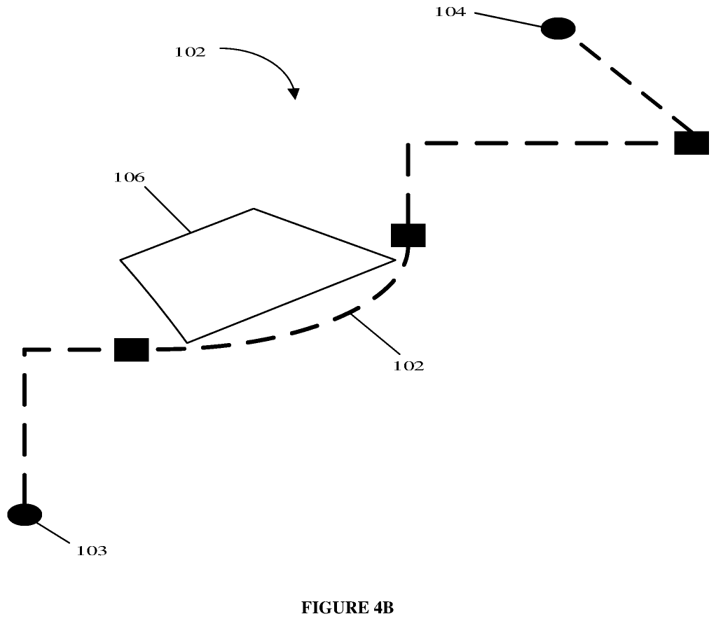

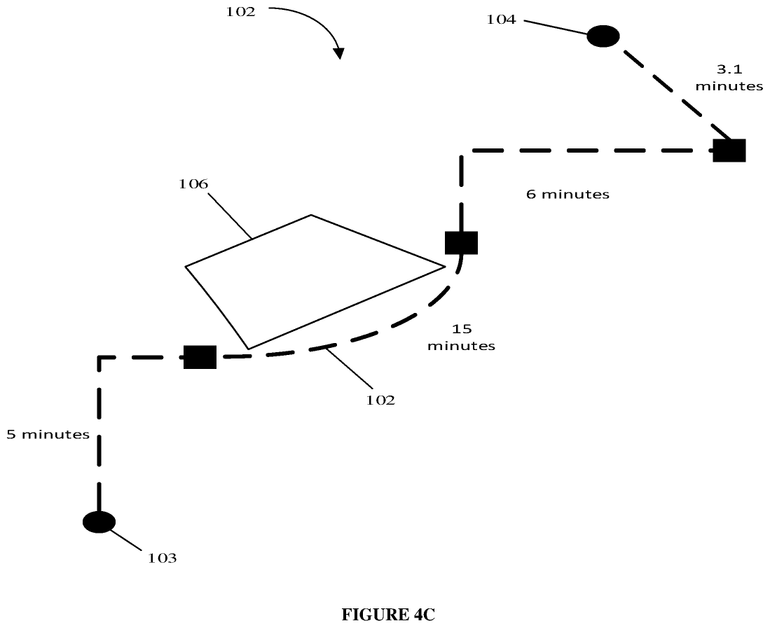

In an embodiment, the computing system (101) may identify the one or more geographical locations (106) causing the delay by modeling the at least one navigation route (102) using the plurality of nodes (denoted by square boxes), the plurality of links (denoted by dotted lines) and the one or more polygons as shown in FIG. 4A. The person skilled in the art appreciates the use of one or more techniques from graph theory for modeling the at least one navigation route (102). Further, the computing system (101) may receive the arrival time to the destination location (104) from the user device (105) as shown in FIG. 4A. The arrival time is determined by the user device (105) based on the distance to the destination location (104) and average speed of the vehicle in the navigation route. For example, the arrival time to the destination location (104) in the at least one navigation path shown in FIG. 4A is 23.8 minutes.

In an embodiment, the computing system (101) may identify the one or more geographical locations (106) causing the delay based on at least one of a distance between the one or more geographical locations (106) and the at least one navigation route (102) and a time taken to navigate from the one or more geographical locations (106) to the link among the plurality of links in the at least one navigation route (102) as shown in FIG. 4B. The one or more geographical locations (106) are indicative of a public gathering present in the vicinity of the at least one navigation route (102) causing the delay to the navigate the vehicle. For example, the one or more geographical locations (106) may be the sports stadium, the movie theater, the shopping mall, the convention hall, the park, and the like. The one or more geographical locations (106) may be identified using a label associated with the one or more geographical locations (106) in the geographical map. The geographical map may be a digital map associated with a city, a state or a country. The computing system (101) identifies the one or more geographical locations (106) causing the delay if the distance between the at least one link from the plurality of links in the at least one navigation route (102) and the one or more geographical locations (106) is less. The distance may be predefined based on the historical information. For example, the one or more geographical locations (106) at the distance of 800 meters from the at least one link of the at least one navigation route (102) may be considered to cause the delay. The distance may be predetermined specific to the geographical area. Further, the computing system (101) identifies the one or more geographical locations (106) causing the delay if the time taken to navigate from the one or more geographical locations (106) to the link among the plurality of links is less than a predetermined value. The predetermined value is computed based on the historical information. For example, if the time taken to travel from the one or more geographical locations (106) to the link among the plurality of the links is less than 15 minutes, the one or more geographical locations (106) is identified to cause the delay. The time taken to travel from the one or more geographical locations (106) to the link of the at least one navigation route (102) may be specific to the geographical area.

In an embodiment, the computing system (101) may identify the one or more factors causing the delay by determining weights associated with the one or more factors. The weights are determined based on the amount of delay caused in navigating the vehicle along the navigation route using the historic information. For example, if the sports tournament causes the delay of 15 minutes, then the weights may be determined as 4.2 and if rainfall causes a delay of 27 minutes, then the weights may be determined as 7.5 and the like. Further, the weights determined for the one or more factors may be specific to the geographical area. Further, the computing system (101) may filter at least one of one or more factors based on the one or more geographical locations (106) causing the delay, the type of the vehicle, type of a path and timestamp of a journey from the source location (103) to the destination location (104). The filtering includes labeling the one or more factors as relevant and irrelevant. The one or more factors labeled as relevant is used to compute the estimated time (108) for the at least one navigation route (102). The one or more factors labeled as irrelevant is not used to compute the estimated time (108) for the at least one navigation route (102). In a first example, the one or more factors indicating the sports tournament in the identified one or more geographical locations (106) may be labeled as relevant. In a second example, the one or more factors indicating an absence of one or more events in the one or more geographical locations (106) is labeled as irrelevant. In a third example, the one or more factors indicating a light drizzle is labeled as irrelevant when the type of the vehicle is a car and labeled as relevant when the type of the vehicle is a motorbike. In a fourth example, the one or more factors indicating a new movie showtime starting at 7:00 PM is labeled as irrelevant when the timestamp of navigation along the at least one navigation route (102) is 12:00 PM.

In an embodiment, the computing system (101) may modify the weights associated with at least one of the one or more factors based on a deviation in a historical estimated time (108) and an actual time for navigating from the source location (103) to the destination location (104) along the at least one navigation route (102). The modification of the weights includes increasing or decreasing the value associated with the weights based on the deviation obtained from the historical information. For example, in a previously completed navigation along the at least one navigation route (102), the computing system (101) had determined the estimated time (108) as 15 minutes due to one or more factors as responsible for causing the delay and the actual time taken to navigate the at least one navigation route (102) was 20 minutes, the computing system (101) identifies the deviation corresponding to the link of the at least one navigation route (102) and further determines the one or more factors causing the additional delay of 5 minutes. Further, the computing system (101) modifies the weights of the determined one or more factors by increasing the value associated with the weights. In another example, for a previously completed navigation along the at least one navigation route (102), the computing system (101) had determined the estimated time (108) as 27 minutes due to one or more factors causing the delay and the actual time taken to navigate the at least one navigation route (102) was 20 minutes, the computing system (101) identifies the deviation corresponding to the link of the at least one navigation route (102) and further determines the one or more factors causing a lesser delay of 7 minutes. Further, the computing system (101) modifies the weights of the determined one or more factors by decreasing the value associated with the weights.

In an embodiment, the computing system (101) may compute the estimated time (108) by determining the estimated time (108) for navigating the vehicle from the source location (103) to the destination location (104) for the at least one navigation route (102) based on the supervised learning technique using weights, the one or more geographical locations (106) causing the delay and the type of the vehicle. For example, the supervised learning technique is regression based model such as linear regression, logistic regression and the like. The computing system (101) may determine the estimated time (108) for each link along the at least one navigation route (102) and add the estimated time (108) of the each link to determine the estimated time (108) from the source location (103) to the destination location (104). The estimated time (108) for the at least one navigation route (102) is provided to the user via the user device (105) for navigating the vehicle before the start of navigation. For example, the estimated time (108) for the at least one navigation route (102) shown in FIG. 4C is computed as “29.1 minutes” using weights, the one or more geographical locations (106) causing the delay and the type of the vehicle. Further, the estimated time (108) for the link in the vicinity of the one or more geographical locations (106) is updated from “9.7 minutes” determined using the distance to the destination location (104) and the average speed of the vehicle as shown in FIG. 4A to “15 minutes” determined based on the one or more geographical locations (106) and the one or more factors causing the delay as shown in FIG. 4C.

In an embodiment, the computing system (101) may compute the actual time taken to travel from the source location (103) to the destination location (104) along the at least one navigation route (102). The at least one navigation route (102) is associated with the unique value for identifying the navigation route. Further, the at least one navigation route (102), the unique value and the timestamp of navigating along the navigation route may be stored as historical information in the storage medium (107). The computing system (101) may use the current GPS location and a timer to determine the actual time taken to travel from the source location (103) to the destination location (104). Further, the actual time taken to travel from the source location (103) to the destination location (104) may be determined by computing the actual time for each link among the plurality of the links and adding the actual time of the each link. When the actual time is greater than the estimated time (108) the computing system (101) may determine at least one of the traffic information, the information related to the one or more events in the geographical area, the weather information and the information related to the roadblock causing the delay to reach the destination location (104). Furthermore, the computing system (101) may update the historical information for the at least one navigation route (102) based on the at least one of the traffic information, the information related to the one or more events in the geographical area, the weather information and the information related to the roadblock.

The method of estimating the time for navigating the vehicle uses the environmental factors including the roadblock, the time of navigation, an occurrence of the one or more events along the navigation route, the current weather status, a predicted weather status, the type of vehicle, traffic information, to compute the estimated time (108) for navigating the vehicle from the source location (103) the destination location (104) accurately before the start of the navigation.

### Computer System

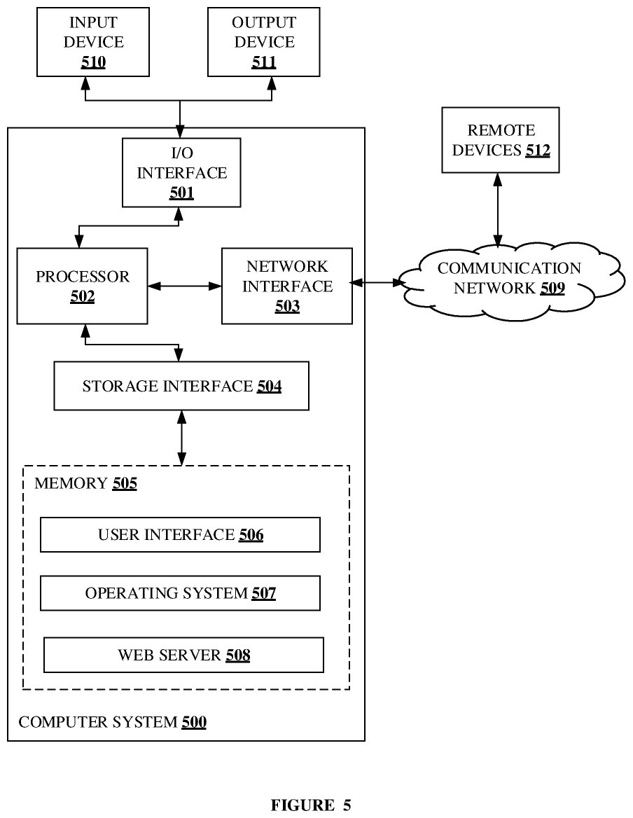

FIG. 5 illustrates a block diagram of an exemplary computer system (500) for implementing embodiments consistent with the present disclosure. In an embodiment, the computer system (500) may be used to implement the method of estimating navigation time of a vehicle. The computer system (500) may comprise a central processing unit (“CPU” or “processor”) (502). The processor (502) may comprise at least one data processor for executing program components for dynamic resource allocation at run time. The processor (502) may include specialized processing units such as integrated system (bus) controllers, memory management control units, floating point units, graphics processing units, digital signal processing units, etc.

The processor (502) may be disposed in communication with one or more input/output (I/O) devices (not shown) via I/O interface (501). The I/O interface (501) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (501), the computer system (500) may communicate with one or more I/O devices. For example, the input device (510) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (511) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (500) is connected to the service operator through a communication network (509). The processor (502) may be disposed in communication with the communication network (509) via a network interface (503). The network interface (503) may communicate with the communication network (509). The network interface (503) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (509) may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface (503) and the communication network (509), the computer system (500) may communicate with the one or more service operators.

In some embodiments, the processor (502) may be disposed in communication with a memory (505) (e.g., RAM, ROM, etc. not shown in FIG. 5 via a storage interface (504). The storage interface (504) may connect to memory (505) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (505) may store a collection of program or database components, including, without limitation, user interface (506), an operating system (507), web server (508) etc. In some embodiments, computer system (500) may store user/application data (506), such as the data, variables, records, etc. as described in this disclosure. Such databases may be implemented as fault-tolerant, relational, scalable, secure databases such as Oracle or Sybase.

The operating system (507) may facilitate resource management and operation of the computer system (500). Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system (500) may implement a web browser (not shown in the Figure) stored program component. The web browser may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers (508) may utilize facilities such as AJAX, HTML, ADOBE® FLASH®, JAVASCRIPT®, JAVA®, Application Programming Interfaces (APIs), etc. In some embodiments, the computer system (500) may implement a mail server stored program component not shown in the Figure). The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some embodiments, the computer system (500) may implement a mail client stored program component not shown in the Figure). The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium (103) refers to any type of physical memory on which information or data readable by a processor may be stored. Thus, a computer-readable storage medium (103) may store instructions for execution by one or more processors, including instructions for causing the processors to perform steps or stages consistent with the embodiments described herein. The term “computer-readable medium” should be understood to include tangible items and exclude carrier waves and transient signals, i.e., non-transitory. Examples include Random Access memory (RAM), Read-Only memory (ROM), volatile memory, non-volatile memory, hard drives, Compact Disc (CD) ROMs, Digital Video Disc (DVDs), flash drives, disks, and any other known physical storage media.

In some implementation, the one or more factors, at least one navigation route (102) may be received from the remote devices (512). In an embodiment, the remote devices (512) may be at least one of the one or more sources, and the user device (105).

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope being indicated by the following claims.

### REFERRAL NUMERALS

| Reference number | Description |
|---|---|
| 101 | Computing system |
| 102 | At least one navigation route |
| 103 | Source location |
| 104 | Destination Location |
| 105 | User Device |
| 106 | One or more geographical locations |
| 107 | Storage Medium |
| 108 | Estimated time |
| 201 | I/O interface |
| 202 | Memory |
| 203 | Processor |
| 204 | Data |
| 205 | Factor Data |
| 206 | Historical Data |
| 207 | Time and Route data |
| 208 | Other data |
| 209 | Modules |
| 210 | Factor Module |
| 211 | Route Modeling Module |
| 212 | Filtering Module |
| 213 | Estimation Module |
| 214 | Other module |
| 500 | Computer System |
| 501 | I/O interface |
| 502 | Processor |
| 503 | Network Interface |
| 504 | Storage Interface |
| 505 | Memory |
| 506 | User Interface |
| 507 | Operating System |
| 508 | Web Server |
| 509 | Communication Network |
| 510 | Input Device |
| 511 | Output Device |
| 512 | Remote Devices |

We claim:

1. A method of estimating navigation time of a vehicle, the method comprising:
obtaining, by a computing system, at least one navigation route from a source location to a destination location from a user via a user device; and
receiving in real-time, by the computing system, at least one of a traffic information, information related to one or more events in a geographical area, a weather information and information related to a roadblock; and
computing, by the computing system, an estimated time for navigating from the source location to the destination location via the at least one navigation route based on identified one or more geographical locations, and one or more factors comprising the traffic information, information related to the one or more events in the geographical area, the weather information and information related to the roadblock causing a delay, and a type of the vehicle, wherein the estimated time for the at least one navigation route is provided to the user for navigating the vehicle.

2. The method as claimed in claim 1, wherein obtaining the at least one navigation route from the source location to the destination location comprises:
receiving the at least one navigation route selected by the user among one or more routes from the source location to the destination location using the user device.

3. The method as claimed in claim 1, wherein identifying the one or more geographical locations causing the delay comprises:
modeling the at least one navigation route using a plurality of nodes, a plurality of links and one or more polygons; and
identifying the one or more geographical locations causing the delay based on at least one of a distance between the one or more geographical locations and the at least one navigation route and a time taken to navigate from the one or more geographical locations to a link among the plurality of links in the at least one navigation route.

4. The method as claimed in claim 1, wherein identifying the one or more factors causing the delay comprises:
determining weights associated with the one or more factors;
filtering at least one of one or more factors based on the one or more geographical locations causing the delay, the type of the vehicle, type of a path and timestamp of a journey from the source location to the destination location; and
modifying the weights associated with at least one of the one or more factors based on a deviation in a historical estimated time and an actual time for navigating from the source location to the destination location along the at least one navigation route.

5. The method as claimed in claim 1, wherein computing the estimated time comprises:
determining the estimated time for navigating from the source location to the destination location for the at least one navigation route based on a supervised learning technique using weights, the one or more geographical locations causing the delay and the type of the vehicle.

6. The method as claimed in claim 1 further comprising:
computing an actual time taken to travel from the source location to the destination location;
determining, when the actual time is greater than the estimated time, at least one of the traffic information, the information related to the one or more events in the geographical area, the weather information and the information related to the roadblock causing the delay to reach the destination location; and
updating a historical information for the at least one navigation route based on the at least one of the traffic information, the information related to the one or more events in the geographical area, the weather information and the information related to the roadblock.

7. A computing system for estimating a navigation time of a vehicle, the computing system comprises:
a processor; and
a memory communicatively coupled to the processor, wherein the memory stores the processor instructions, which, on execution, causes the processor to perform:
obtain at least one navigation route from a source location to a destination location from a user via a user device;
receive in real-time at least one of a traffic information, information related to one or more events in a geographical area, a weather information and information related to a roadblock; and
compute an estimated time for navigating from the source location to the destination location via the at least one navigation route based on identified one or more geographical locations, and one or more factors comprising the traffic information, information related to the one or more events in the geographical area, the weather information and information related to the roadblock causing delay and a type of the vehicle, wherein the estimated time for the at least one navigation route is provided to the user for navigating the vehicle.

8. The computing system as claimed in claim 7, wherein the processor is configured to obtain the at least one navigation route from the source location to the destination location comprises:
receiving the at least one navigation route selected by the user among one or more routes from the source location to the destination location using the user device.

9. The computing system as claimed in claim 7, wherein the processor is configured to identify the one or more geographical locations causing the delay comprises:
modeling the at least one navigation route using a plurality of nodes, a plurality of links and one or more polygons; and
identifying the one or more geographical locations causing the delay based on at least one of a distance between the one or more geographical locations and the at least one navigation route and a time taken to navigate from the one or more geographical locations to a link among the plurality of links in the at least one navigation route.

10. The computing system as claimed in claim 7, wherein the processor is configured to identify the one or more factors causing the delay comprises:
determining weights associated with the one or more factors;
filtering at least one of one or more factors based on the one or more geographical locations causing the delay, the type of the vehicle, type of a path and timestamp of a journey from the source location to the destination location; and
modifying the weights associated with at least one of the one or more factors based on a deviation in a historical estimated time and an actual time for navigating from the source location to the destination location along the at least one navigation route.

11. The computing system as claimed in claim 7, wherein the processor is configured to compute the estimated time comprises:
determining the estimated time for navigating from the source location to the destination location for the at least one navigation route based on a supervised learning technique using weights, the one or more geographical locations causing the delay and the type of the vehicle.

12. The computing system as claimed in claim 7, wherein the processor is further configured to:
compute an actual time taken to travel from the source location to the destination location;
determine, when the actual time is greater than the estimated time, at least one of the traffic information, the information related to the one or more events in the geographical area, the weather information and the information related to the roadblock causing the delay to reach the destination location; and
update a historical information for the at least one navigation route based on the determined at least one of the traffic information, the information related to the one or more events in the geographical area, the weather information and the information related to the roadblock.

13. A non-transitory computer readable medium including instructions stored thereon that when processed by at least one processor cause a device to perform operations comprising:
obtaining, by a computing system, at least one navigation route from a source location to a destination location from a user via a user device;
receiving in real-time, by the computing system, at least one of a traffic information, information related to one or more events in a geographical area, a weather information and information related to a roadblock; and
computing, by the computing system, an estimated time for navigating from the source location to the destination location via the at least one navigation route based on identified one or more geographical locations, and one or more factors comprising the traffic information, information related to the one or more events in the geographical area, the weather information and information related to the roadblock causing a delay, and a type of the vehicle, wherein the estimated time for the at least one navigation route is provided to the user for navigating the vehicle.

14. The media of claim 13, wherein the instructions causes the processor to obtain the at least one navigation route from the source location to the destination location comprises:
receiving the at least one navigation route selected by the user among one or more routes from the source location to the destination location using the user device.

15. The media of claim 13, wherein the instructions causes the processor to identify the one or more geographical locations causing the delay comprises:
modeling the at least one navigation route using a plurality of nodes, a plurality of links and one or more polygons; and
identifying the one or more geographical locations causing the delay based on at least one of a distance between the one or more geographical locations and the at least one navigation route and a time taken to navigate from the one or more geographical locations to a link among the plurality of links in the at least one navigation route.

16. The media of claim 13, wherein the instructions causes the processor to identify the one or more factors causing the delay comprises:
determining weights associated with the one or more factors;
filtering at least one of one or more factors based on the one or more geographical locations causing the delay, the type of the vehicle, type of a path and timestamp of a journey from the source location to the destination location; and
modifying the weights associated with at least one of the one or more factors based on a deviation in a historical estimated time and an actual time for navigating from the source location to the destination location along the at least one navigation route.

17. The media of claim 13, wherein the instructions causes the processor to compute the estimated time comprises:
determining the estimated time for navigating from the source location to the destination location for the at least one navigation route based on a supervised learning technique using weights, the one or more geographical locations causing the delay and the type of the vehicle.

18. The media of claim 13, wherein the instructions causes the processor to:
compute an actual time taken to travel from the source location to the destination location;
determine, when the actual time is greater than the estimated time, at least one of the traffic information, the information related to the one or more events in the geographical area, the weather information and the information related to the roadblock causing the delay to reach the destination location; and
update a historical information for the at least one navigation route based on the determined at least one of the traffic information, the information related to the one or more events in the geographical area, the weather information and the information related to the roadblock.
